(19) United States
(12) Patent Application Publication
(10) Pub. No.: US 2021/0129479 A1
(43) Pub. Date: May 6, 2021

(54) Gypsum Panel Containing a Fluted Layer

(71) Applicant: National Gypsum Properties, LLC, Charlotte, NC (US)

(72) Inventors: Michael N. Blades, Indian Land, SC (US); Dalton Steed, Charlotte, NC (US); Thomas R. Wilson, Dallas, GA (US); Dallas King, Charlotte, NC (US)

(21) Appl. No.: 17/084,822

(22) Filed: Oct. 30, 2020

Related U.S. Application Data
(60) Provisional application No. 62/928,582, filed on Oct. 31, 2019.

(51) Int. Cl. B32B 3/28; B32B 5/02; B32B 13/08; B32B 3/26; B32B 13/06; C04B 28/14; B32B 13/14

(52) U.S. Cl. CPC B32B 3/28; B32B 5/02; B32B 13/08; B32B 3/266; C04B 2111/0062; C04B 28/14; B32B 13/14; B32B 2315/18; B32B 2262/101; B32B 13/06

(57) ABSTRACT

In the present disclosure, a gypsum panel is disclosed. The gypsum panel comprises a gypsum core having a first gypsum layer surface and a second gypsum layer surface opposite the first gypsum layer surface and a fluted layer having a first fluted layer surface and a second fluted layer surface opposite the first fluted layer surface wherein the first fluted layer surface facing the first gypsum layer surface. The present disclosure is also directed to a method of forming the aforementioned gypsum panel.

### CROSS-REFERENCE TO RELATED APPLICATION

The present application claims filing benefit of U.S. Provisional Patent Application Ser. No. 62/928,582 having a filing date of Oct. 31, 2019, and which is incorporated herein by reference in its entirety.

### BACKGROUND

A building is typically constructed with walls and ceilings having a frame comprising studs wherein one or more gypsum panels are fastened to the studs. For instance, for interior walls, one or more gypsum panels are fastened to each side of the studs while for exterior walls and ceilings one or more gypsum panels are generally fastened to one side of the studs. Walls and ceilings of this construction often have poor acoustical performance resulting in a low sound transmission class (STC) rating and/or a low noise reduction coefficient (NRC). Such low values can result in noise pollution, lack of privacy, and similar issues in the various spaces of the building.

As a result, there is a need to further improve the acoustical performance of gypsum panels.

### SUMMARY OF THE INVENTION

In accordance with one embodiment of the present invention, a gypsum panel is disclosed. The gypsum panel comprises a gypsum core having a first gypsum layer surface and a second gypsum layer surface opposite the first surface. The gypsum panel further comprises a fluted layer having a first fluted layer surface and a second fluted layer surface opposite the first fluted layer surface wherein the first fluted layer surface faces the first gypsum layer surface.

In accordance with another embodiment of the present invention, a method of forming a gypsum panel is disclosed. The method comprises depositing a gypsum slurry comprising stucco and water onto a fluted layer, providing an encasing layer on the gypsum slurry, and allowing the stucco to convert to calcium sulfate dihydrate.

In accordance with another embodiment of the present invention, a method of forming a gypsum panel is disclosed. The method comprises depositing a gypsum slurry comprising stucco and water onto a first encasing layer, providing a fluted layer on the gypsum slurry, providing a second encasing layer on the fluted layer; and allowing the stucco to convert to calcium sulfate dihydrate.

### BRIEF DESCRIPTION OF THE DRAWINGS

The invention will now be described, by way of example, with reference to the accompanying drawings, in which:

FIG. 1 is an example of one gypsum panel including a fluted layer according to the present invention;

FIG. 2 is an example of one gypsum panel including a fluted layer according to the present invention; and

FIG. 3 is an example of perforations on an encasing layer of the present invention.

### DETAILED DESCRIPTION

Reference now will be made in detail to embodiments, one or more examples of which are illustrated in the drawings. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present invention is directed to a gypsum panel including a fluted layer. As generally known in the art, these fluted layers are typically employed in certain corrugated materials, such as in certain heavy-duty paper-based materials. By utilizing the fluted layer within or as part of the gypsum panel, the gypsum panel may provide a desired noise reduction and/or sound absorbance, in particular for ceiling applications. For instance, the gypsum panel may provide a particular noise reduction coefficient that is desired for various environments. In turn, the gypsum panels may provide a more desired acoustic experience for individuals in the presence of such panels.

The noise reduction coefficient (“NRC”) is generally a measure of the sound absorption property of a gypsum panel. Generally, an NRC value may range from 0 to 1. As an example, an NRC value of 0.7 means that approximately 70% of the sound is absorbed by a panel, while approximately 30% is reflected back into the environment. In this regard, gypsum panels made according to the present invention may have higher NRC values than other types of gypsum panels, indicating improved sound absorbance and acoustical properties. For instance, the NRC value of the gypsum panel disclosed herein may be 0.15 or more, such as 0.2 or more, such as 0.3 or more, such as 0.4 or more, such as 0.5 or more, such as 0.6 or more, such as 0.7 or more, such as 0.8 or more. The NRC value of the gypsum panel may be 1 or less, such as 0.95 or less, such as 0.9 or less, such as 0.8 or less, such as 0.7 or less, such as 0.6 or less, such as 0.5 or less. In one embodiment, the aforementioned NRC values are based on ASTM C423, herein incorporated by reference in its entirety. In another embodiment, the aforementioned NRC values are based on ASTM E1050, herein incorporated by reference in its entirety. For example, such latter test may be employed for small-scale testing.

As indicated above, in general, the present invention is directed to a gypsum panel. The gypsum panel includes a gypsum core. In general, the composition of the gypsum core is not necessarily limited and may be any gypsum core generally known in the art. Regardless, the gypsum core is typically made from a gypsum slurry including at least stucco and water.

In general, stucco may be referred to as calcined gypsum or calcium sulfate hemihydrate. The calcined gypsum may be from a natural source or a synthetic source and is thus not necessarily limited by the present invention. In addition to the stucco, the gypsum slurry may also contain some calcium sulfate dihydrate or calcium sulfate anhydrite. If calcium sulfate dihydrate is present, the calcium sulfate hemihydrate may be present in an amount of at least 50 wt. %, such as at least 60 wt. %, such as at least 70 wt. %, such as at least 80 wt. %, such as at least 85 wt. %, such as at least 90 wt. %, such as at least 95 wt. %, such as at least 98 wt. %, such as at least 99 wt. % based on the weight of the calcium sulfate hemihydrate and the calcium sulfate dihydrate. Furthermore, the calcined gypsum may be α-hemihydrate, β-hemihydrate, or a mixture thereof.

In addition to the stucco, the gypsum slurry may also contain other hydraulic materials, which may also be present in the gypsum core. These hydraulic materials may include calcium sulfate anhydrite, land plaster, cement, fly ash, or any combinations thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the hydraulic material.

As indicated above, the gypsum slurry also includes water. Water may be employed for fluidity and also for rehydration of the stucco to allow for setting. The amount of water utilized is not necessarily limited by the present invention.

For instance, the weight ratio of the water to the stucco may be 0.1 or more, such as 0.2 or more, such as 0.3 or more, such as 0.4 or more, such as 0.5 or more. The weight ratio of the water to the stucco may be 4 or less, such as 3.5 or less, such as 3 or less, such as 2.5 or less, such as 2 or less, such as 1.7 or less, such as 1.5 or less, such as 1.4 or less, such as 1.3 or less, such as 1.2 or less, such as 1.1 or less, such as 1 or less, such as 0.9 or less, such as 0.85 or less, such as 0.8 or less, such as 0.75 or less, such as 0.7 or less, such as 0.6 or less, such as 0.5 or less, such as 0.4 or less, such as 0.35 or less, such as 0.3 or less, such as 0.25 or less, such as 0.2 or less.

In addition to the stucco and water, the gypsum slurry may also include any other conventional additives as known in the art. Accordingly, these conventional additives may also be present in the gypsum core. In this regard, such additives are not necessarily limited by the present invention. For instance, the additives may include dispersants, foam or foaming agents including aqueous foam (e.g. surfactants), set accelerators (e.g., BMA, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, starches (such as pregelatinized starch, non-pregelatinized starch, and/or an acid modified starch), colorants, fire retardants or additives (e.g., silica, silicates, expandable materials such as vermiculite, perlite, etc.), water repellants, fillers (e.g., glass fibers), waxes, secondary phosphates (e.g., condensed phosphates or orthophosphates including trimetaphosphates, polyphosphates, and/or cyclophosphates, etc.), sound dampening polymers (e.g., viscoelastic polymers), natural and synthetic polymers, etc. In general, it should be understood that the types and amounts of such additives are not necessarily limited by the present invention.

In general, when present, each additive may be present in the gypsum slurry in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more based on the weight of the stucco. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.2 wt. % or less based on the weight of the stucco.

In general, the gypsum core has a first gypsum layer surface and a second gypsum layer surface opposite the first gypsum layer surface. As indicated herein, the gypsum panel also includes a fluted layer. In this regard, the fluted layer may be disposed on a gypsum layer surface. For instance, in one embodiment, the fluted layer may be disposed on the first gypsum layer surface. In another embodiment, the fluted layer may be disposed on the second gypsum layer surface. In a further embodiment, the fluted layer may be disposed on the first gypsum layer surface and the second gypsum layer surface. When the fluted layer is provided on only one gypsum layer surface, an encasing layer as disclosed herein may be disposed on the other gypsum layer surface.

The fluted layer may have a first fluted layer surface facing the gypsum layer surface and a second fluted layer surface opposite the first fluted layer surface. In one embodiment, the fluted layer may be directly disposed on the gypsum layer surface such that the first fluted layer surface is in contact with the gypsum layer surface. When the fluted layer is provided directly on the gypsum layer surface, there may be minimal voids such that the space between the fluted layer and the gypsum core is occupied by the gypsum core. In this regard, when viewing a cross-section of the gypsum panel, 50% or less, such as 40% or less, such as 30% or less, such as 25% or less, such as 20% or less, such as 15% or less, such as 10% or less, such as 5% or less, such as 4% or less, such as 3% or less, such as 2% or less of the cross-sectional area of the space between the fluted layer and the gypsum core may be unoccupied by the gypsum core. Similarly, 50% or more, such as 60% or more, such as 70% or more, such as 75% or more, such as 80% or more, such as 85% or more, such as 90% or more, such as 95% or more, such as 96% or more, such as 97% or more, such as 98% or more of the cross-sectional area of the space between the fluted layer and the gypsum core is occupied by the gypsum core. Such area can be determined based on the area under the peaks and between the adjacent respective troughs (e.g., wherein an imaginary line connects the lowest point of two adjacent troughs for providing a defined area).

In another embodiment, the fluted layer may be indirectly disposed on the gypsum layer surface such that the first fluted layer surface is not directly in contact with the gypsum layer surface. For instance, an intermediate layer, such as an encasing layer as described herein, may be disposed between the fluted layer and the gypsum core. In this regard, such encasing layer may have a first encasing layer surface adjacent the gypsum layer surface and a second encasing layer surface opposite the first encasing layer surface. Accordingly, such first encasing layer surface may be in contact with the gypsum layer surface and such second encasing layer surface may be in contact with the first fluted layer surface.

In one embodiment, the second fluted layer surface opposite the gypsum layer surface may include an encasing layer. In particular, such an encasing layer may include a first encasing layer and a second encasing layer. For instance, when providing the fluted layer on the gypsum core, such a fluted layer may be carried on an encasing layer. As indicated above, such an encasing layer may be adjacent and in contact with the gypsum layer surface in one embodiment. In another embodiment, such an encasing layer may be adjacent the second fluted layer surface opposite the gypsum layer surface. In addition, in one embodiment, a second encasing layer may be provided on the first encasing layer provided on the fluted layer.

The fluted layer may be one having any number of flutes. As an example, the flutes may be an A flute, a B flute, a C flute, a D flute, an E flute, an F flute, or a G flute. However, it should be understood that different types of flutes may also be employed within the fluted layer. For instance, a single fluted layer may contain flutes having different sizes and/or dimensions.

In addition, the fluted layer may have 5 or more, such as 10 or more, such as 20 or more, such as 30 or more, such as 40 or more, such as 50 or more, such as 70 or more, such as 90 or more, such as 100 or more, such as 120 or more, such as 150 or more flutes per foot. It may have 300 or less, such as 250 or less, such as 200 or less, such as 180 or less, such as 160 or less, such as 140 or less, such as 130 or less, such as 110 or less, such as 100 or less, such as 80 or less, such as 60 or less, such as 50 or less, such as 40 or less, such as 35 or less, such as 25 or less flutes per foot.

The fluted layer may have a particular thickness. For instance, the thickness of the fluted layer may be 0.01 mm or more, such as 0.05 mm or more, such as 0.1 mm or more, such as 0.2 mm or more, such as 0.25 mm or more, such as 0.3 mm or more, such as 0.5 mm or more, such as 1 mm or more, such as 2 mm or more, such as 3 mm or more, such as 5 mm or more, such as 7 mm or more, such as 9 mm or more, such as 10 mm or more. The thickness of the fluted layer may be 50 mm or less, such as 40 mm or less, such as 30 mm or less, such as 25 mm or less, such as 20 mm or less, such as 18 mm or less, such as 15 mm or less, such as 14 mm or less, such as 13 mm or less, such as 12 mm or less, such as 11 mm or less, such as 10 mm or less, such as 9 mm or less, such as 8 mm or less, such as 7 mm or less, such as 6 mm or less, such as 5 mm or less, such as 4 mm or less, such as 3 mm or less, such as 2 mm or less, such as 1 mm or less, such as 0.8 mm or less, such as 0.6 mm or less, such as 0.5 mm or less, such as 0.4 mm or less, such as 0.3 mm or less, such as 0.2 mm or less.

The fluted layer may have a particular basis weight. For instance, the fluted layer may have a basis weight of 0.001 pounds per square foot or more, such as 0.005 pounds per square foot or more, such as 0.01 pounds per square foot or more, such as 0.015 pounds per square foot or more, such as 0.02 pounds per square foot or more, such as 0.025 pounds per square foot or more, such as 0.03 pounds per square foot or more, such as 0.04 pounds per square foot or more, such as 0.05 pounds per square foot or more, such as 0.1 pounds per square foot or more, such as 0.2 pounds per square foot or more, such as 0.3 pounds per square foot or more, such as 0.4 pounds per square foot or more, such as 0.5 pounds per square foot or more, such as 0.7 pounds per square foot or more. The basis weight of the fluted layer may be 2 pounds per square foot or less, such as 1.8 pounds per square foot or less, such as 1.5 pounds per square foot or less, such as 1.3 pounds per square foot or less, such as 1.1 pounds per square foot or less, such as 1 pound per square foot or less, such as 0.8 pounds per square foot or less, such as 0.6 pounds per square foot or less, such as 0.5 pounds per square foot or less, such as 0.4 pounds per square foot or less, such as 0.3 pounds per square foot or less, such as 0.2 pounds per square foot or less, such as 0.15 pounds per square foot or less, such as 0.1 pounds per square foot or less, such as 0.09 pounds per square foot or less, such as 0.07 pounds per square foot or less, such as 0.05 pounds per square foot or less, such as 0.04 pounds per square foot or less, such as 0.03 pounds per square foot or less.

In one embodiment, the fluted layer may be a single layer. For instance, the fluted layer may include only one fluted layer.

In another embodiment, the fluted layer may resemble a double wall layer. For instance, the fluted layer may include a first fluted layer and a second fluted layer. Each fluted layer may be the same or may be different. In one embodiment, each fluted layer is different. With two fluted layers, the first fluted layer may be separated from the second fluted layer by an encasing layer as described herein.

In a further embodiment, the fluted layer may resemble a triple wall layer. For instance, the fluted layer may include a first fluted layer, a second fluted layer, and a third fluted layer. Each fluted layer may be the same or may be different. In one embodiment, each fluted layer is different. With three fluted layers, the first fluted layer may be separated from the second fluted layer by an encasing layer as described herein and the second fluted layer may be separated from the third fluted layer by an encasing layer as described herein.

Furthermore, the material of the fluted layer may be any as generally known in the art. For instance, in one embodiment, the fluted layer may be a cellulosic material, such as a paper. As an example, the fluted layer may be a cardboard type material. In another embodiment, the fluted layer may be made from a metal. For instance, the metal may include a steel (e.g., galvanized steel, stainless steel), aluminum, or other types of metals generally utilized in forming fluted layers.

In one embodiment, the fluted layer may also include a coating. The coating may be provided on the fluted layer to provide various benefits. In one embodiment, the coating may be provided on the first fluted layer surface. In another embodiment, the coating may be provided on the second fluted layer surface. In a further embodiment, the coating may be provided on the first fluted layer surface and the second fluted layer surface.

The coating is not necessarily limited by the present invention and may include a flame retardant, an intumescent, a charring agent, a polymer, a nonwoven, a foam, or a combination thereof. In one embodiment, the coating includes a flame retardant. In another embodiment, the coating includes an intumescent. In one embodiment, the coating includes a charring agent. In a further embodiment, the coating includes a polymer. In another further embodiment, the coating includes a nonwoven. In a further embodiment, the coating includes a foam.

In one embodiment, the coating includes at least two of the aforementioned components. In another embodiment, the coating includes at least three of the aforementioned components.

In one embodiment, the coating may include a flame retardant. The flame retardant may include an organohalogen flame retardant, an organophosphorus flame retardant, an isocyanurate flame retardant, a melamine based flame retardant, or a mixture thereof. Organohalogen flame retardants may include, but are not limited to, chloroalkyl phosphate esters, tri(2-chloroethyl)phosphate, polybrominated diphenyl oxide, tris(2,3-dibromopropyl)phosphate, tetrachlorophthalic acid, tetrabromophthalic acid, and the like. Organophosphorus flame retardants may include, but are not limited to, tetraphenyl resorcinol diphosphate, triphenyl phosphate, trioctyl phosphate, tricresyl phosphate, hydroxyalkyl esters of phosphorus acids, ammonium polyphosphate, phosphazenes, ethylenediamine diphosphate, etc. Isocyanurate flame retardants may include, but are not limited to, esters of isocyanuric acid and isocyanurates, hydroxyalkyl isocyanurate (e.g., tris-(2-hydroxyethyl)isocyanurate, tris(hydroxymethyl)isocyanurate, tris(3-hydroxy-n-proyl)isocyanurate, triglycidyl isocyanurate, etc.), and the like. Melamine based flame retardants may include, but are not limited to, melamine cyanurate, melamine borate, melamine phosphates, melamine polyphosphates and melamine pyrophosphates, and the like.

In one embodiment, the coating may include an intumescent material. Generally, intumescent materials undergo a change (e.g., chemical or physical) when exposed to heat or a flame in order to protect the underlying material and/or surface. In particular, these materials may be passive components which remain inactive until subjected to heat or a certain temperature (e.g., when exposed to a flame). For example, in one embodiment, such heat or flame may cause the material to expand. In this regard, these materials may increase the flame resistance of the gypsum panel.

Intumescent materials may include perlite, vermiculite, a silicate (e.g., sodium silicates, mica, etc.), graphite (e.g., expandable graphite), or a mixture thereof. In one embodiment, the intumescent material may include perlite, vermiculite, a silicate, or a mixture thereof. In a further embodiment, the intumescent material may include perlite. In another embodiment, the intumescent material may include vermiculite. In a further embodiment, the intumescent material may include a silicate.

In one embodiment, the intumescent material may expand upon exposure to heat or a high temperature. In this regard, the intumescent material may expand 50% or more, such as 60% or more, such as 70% or more, such as 80% or more, such as 90% or more, such as 100% or more, such as 125% or more, such as 150% or more, such as 200% or more, such as 250% or more, such as 300% or more of its original volume. Such expansion may be at a temperature of at least 100° C., such as at least at least 200° C., such as at least 300° C., such as at least 400° C., such as at least, 500° C., such as at least 600° C., such as at least 700° C., such as at least 800° C.

In one embodiment, the coating may include a charring agent. The charring agent may include, but is not limited to, dextrin, glycerol, sorbitol, starch, pentaerythritol, dipentaerythritol, inositol, amylose, polysaccharides (e.g., water-soluble polysaccharides), and mixtures thereof.

In another embodiment, the coating may include a polymer. In general, the polymer may be a thermoplastic polymer. However, in one embodiment, the polymer may be a thermoset polymer. The polymer may also be one that expands, such as like a foam, when exposed to heat and/or a flame. The polymer may include an acrylic polymer, a fluoropolymer, an epoxy, a urethane, a cyanurate, a rubber, an acetate polymer, or a mixture thereof. In one embodiment, the polymer may include an acrylic polymer (e.g., a vinyl toluene acrylic polymer, a styrene acrylic polymer, a silicone acrylic polymer, or a mixture thereof). In another embodiment, the polymer may include a fluoropolymer (e.g., polytetrafluoroethylene). In a further embodiment, the polymer may include an epoxy. In another further embodiment, the polymer may include a urethane polymer (e.g., polyurethane). In one embodiment, the polymer may include a cyanurate (e.g., polyisocyanurate). In a further embodiment, the polymer may include a rubber (e.g., chlorinated rubber). In another embodiment, the polymer may include an acetate polymer (e.g., polyvinyl acetate). One example of a commercially available polymer coating, in particular a polyvinyl acetate coating, may be CAFCO® SprayFilm® polymer coating.

In one embodiment, the polymer may be a viscoelastic polymer. For instance, the aforementioned acrylic polymer may be a viscoelastic polymer. In particular, the acrylic polymer may be an acrylic copolymer. In this regard, the polymer may be presented as a viscoelastic material having a broad glass transition temperature, in particular below room temperature. Such viscoelastic material may also include other additives as generally employed in the art and thus is not limited by the present invention. In general, such viscoelastic materials allow for sound to be absorbed by the material thereby reducing the sound's amplitude and resulting energy of the sound.

Furthermore, the coating may be applied to the fluted layer using techniques known in the art. For example, the coating may be a water-based coating that is applied to the fluted layer and thereafter allowed to dry in order to form the coating. The water-based coating may be a solution or a dispersion. However, it should be understood that other liquids/solvents may be used in addition to or in lieu of water. Furthermore, depending on the viscosity of the polymer, it should be understood that the polymer may be applied without a liquid or solvent. For example, the polymer may be applied as a melt that is able to spread onto the fluted layer. In one embodiment, the polymer may be applied on the encasing layer, such as on an exterior surface of the encasing layer.

The thickness of the coating layer is not necessarily limited. For instance, the coating layer may have a thickness of 0.01 mm or more, such as 0.05 mm or more, such as 0.1 mm or more, such as 0.2 mm or more, such as 0.25 mm or more, such as 0.3 mm or more, such as 0.5 mm or more, such as 1 mm or more, such as 2 mm or more, such as 3 mm or more, such as 5 mm or more, such as 7 mm or more, such as 9 mm or more, such as 10 mm or more. The coating layer may have a thickness of 30 mm or less, such as 20 mm or less, such as 18 mm or less, such as 15 mm or less, such as 14 mm or less, such as 13 mm or less, such as 12 mm or less, such as 11 mm or less, such as 10 mm or less, such as 9 mm or less, such as 8 mm or less, such as 7 mm or less, such as 6 mm or less, such as 5 mm or less, such as 4 mm or less, such as 3 mm or less, such as 2 mm or less, such as 1 mm or less, such as 0.8 mm or less, such as 0.6 mm or less, such as 0.5 mm or less, such as 0.4 mm or less, such as 0.3 mm or less, such as 0.2 mm or less.

The encasing layers as described herein may be any encasing layer as generally employed in the art. For instance, the encasing layer may be a paper or cellulosic encasing layer, a fibrous (e.g., glass fiber) mat encasing layer, a scrim encasing layer, or a polymeric encasing layer. In one embodiment, the encasing layer is a paper or cellulosic encasing layer. In another embodiment, the encasing layer is a glass mat encasing layer. In a further embodiment, the encasing layer is a scrim encasing layer. In another further embodiment, the encasing layer is a polymeric encasing layer.

It should be understood that the encasing layers employed in the gypsum panel may be all of the same type of material. Alternatively, it should also be understood that the encasing layers employed in the gypsum panel may be of different types of materials.

For instance, an encasing layer provided directly on the gypsum layer surface may be a paper or cellulosic encasing layer in one embodiment. In another embodiment, such encasing layer may be a glass fiber mat encasing layer. In a further embodiment, a paper or cellulosic encasing layer may be provided on one gypsum layer surface and a glass fiber mat encasing layer may be provided on the other gypsum layer surface.

In addition, if the fluted layer is provided on an encasing layer, such encasing layer in one embodiment may be a paper or cellulosic encasing layer. When such encasing layer is provided on the second fluted layer surface (i.e., the surface not facing the gypsum core), such encasing layer may be provided with a second encasing layer. For instance, the second encasing layer may be any of the aforementioned encasing layers. In one particular embodiment, such encasing layer is a paper or cellulosic encasing layer. In another embodiment, such encasing layer is a glass fiber mat encasing layer.

The thickness of the encasing layers is not necessarily limited. For instance, the encasing layer may have a thickness of 0.01 mm or more, such as 0.05 mm or more, such as 0.1 mm or more, such as 0.2 mm or more, such as 0.25 mm or more, such as 0.3 mm or more, such as 0.5 mm or more, such as 1 mm or more, such as 2 mm or more, such as 3 mm or more, such as 5 mm or more, such as 7 mm or more, such as 9 mm or more, such as 10 mm or more. The encasing layer may have a thickness of 50 mm or less, such as 40 mm or less, such as 30 mm or less, such as 25 mm or less, such as 20 mm or less, such as 18 mm or less, such as 15 mm or less, such as 14 mm or less, such as 13 mm or less, such as 12 mm or less, such as 11 mm or less, such as 10 mm or less, such as 9 mm or less, such as 8 mm or less, such as 7 mm or less, such as 6 mm or less, such as 5 mm or less, such as 4 mm or less, such as 3 mm or less, such as 2 mm or less, such as 1 mm or less, such as 0.8 mm or less, such as 0.6 mm or less, such as 0.5 mm or less, such as 0.4 mm or less, such as 0.3 mm or less, such as 0.2 mm or less.

In one embodiment, the encasing layer provided on the fluted layer may also have a plurality of perforations. In particular, the encasing layer provided on or facing the second fluted layer surface may have a plurality of perforations.

Generally, the shape of the perforations may not necessarily be limited. For instance, the perforations may generally have a shape that is a circle, oval, square, rectangle, triangle, diamond, or any combination thereof. In one embodiment, the perforations all have one type of shape. In another embodiment, the perforations include a combination of shapes. Nevertheless, it should be understood however that the perforations may also have an irregular shape.

In addition, it should be understood that the perforations may also have various sizes. For instance, in one embodiment, the perforations may all have substantially the same size. In this regard, the perforations may have a regular size distribution, such that the area of each perforation is substantially similar. In another embodiment, the perforations may include at least two or more sizes. In this regard, the perforations may have an irregular size distribution, such that the area of more than one perforation is different. For instance, one perforation may generally be of a larger size than another perforation. Nevertheless, when taking into account all of the perforations, the average maximum dimension of the perforations may be 0.1 mm or more, such as 0.2 mm or more, such as 0.5 mm or more, such as 0.7 mm or more, such as 0.9 mm or more, such as 1 mm or more, such as 1.25 mm or more, such as 1.5 mm or more, such as 2 mm or more, such as 2.5 mm or more, such as 3 mm or more, such as 4 mm or more, such as 5 mm or more, such as 6 mm or more, such as 7 mm or more, such as 8 mm or more, such as 9 mm or more, such as 10 mm or more. The average maximum dimension of the perforations may be 50 mm or less, such as 40 mm or less, such as 30 mm or less, such as 25 mm or less, such as 20 mm or less, such as 18 mm or less, such as 15 mm or less, such as 14 mm or less, such as 13 mm or less, such as 12 mm or less, such as 11 mm or less, such as 10 mm or less, such as 9 mm or less, such as 8 mm or less, such as 7 mm or less, such as 6 mm or less, such as 5 mm or less, such as 4 mm or less, such as 3 mm or less, such as 2 mm or less.

In addition, the perforations may be substantially uniformly spaced in one embodiment. For instance, the center-to-center distance between adjacent perforations may be substantially the same. However, in another embodiment, the perforations may not be substantially uniformly spaced. For instance, the perforations may be provided on the encasing layer in a non-uniform arrangement. For example, the perforations may be provided as a design.

Regardless, the average center-to-center distance of the perforations may be 0.1 mm or more, such as 0.2 mm or more, such as 0.5 mm or more, such as 0.7 mm or more, such as 0.9 mm or more, such as 1 mm or more, such as 1.25 mm or more, such as 1.5 mm or more, such as 2 mm or more, such as 2.5 mm or more, such as 3 mm or more, such as 4 mm or more, such as 5 mm or more, such as 6 mm or more, such as 7 mm or more, such as 8 mm or more, such as 9 mm or more, such as 10 mm or more, such as 15 mm or more, such as 20 mm or more, such as 25 mm or more. The average center-to-center distance of the perforations may be 50 mm or less, such as 40 mm or less, such as 30 mm or less, such as 25 mm or less, such as 20 mm or less, such as 18 mm or less, such as 15 mm or less, such as 14 mm or less, such as 13 mm or less, such as 12 mm or less, such as 11 mm or less, such as 10 mm or less, such as 9 mm or less, such as 8 mm or less, such as 7 mm or less, such as 6 mm or less, such as 5 mm or less. In one embodiment, the aforementioned may refer to an end-to-end distance between perforations rather than a center-to-center distance.

The perforations may cover 0.5% or more, such as 1% or more, such as 2% or more, such as 3% or more, such as 5% or more, such as 7% or more, such as 10% or more, such as 15% or more, such as 20% or more, such as 25% or more, such as 30% or more, such as 40% or more, such as 50% or more of the surface area of the encasing layer. The perforations may cover 70% or less, such as 60% or less, such as 50% or less, such as 40% or less, such as 30% or less, such as 25% or less, such as 20% or less, such as 15% or less, such as 10% or less, such as 9% or less, such as 8% or less, such as 6% or less of the surface area of the encasing layer.

The perforations may be formed using any method generally known in the art. For instance, the perforations may be formed by drilling, punching, or other known hole-making techniques. Furthermore, the perforations may be formed in the encasing layer prior to providing the encasing layer for forming the gypsum panel. For instance, the perforations may be formed prior to providing the encasing layer on a conveying system, regardless of whether the encasing layer is provided prior to deposition of the gypsum slurry or after deposition of the gypsum slurry. Alternatively, the encasing layer may be provided for forming the gypsum panel and the perforations may be formed thereafter.

In this regard, in one embodiment, the perforations may be provided in the encasing layer but not in the gypsum core. For instance, the perforations may be provided such that they expose the “valleys” between the “peaks” of the fluted layer. In a further embodiment, the perforations may be provided in the encasing layer and the fluted layer. In an even further embodiment, the perforations may be provided in the encasing layer, the fluted layer, and the gypsum core. If the perforations are present in the gypsum core, it should be understood that such perforations may only penetrate a certain distance within the core. For instance, the perforations may penetrate 50% or less, such as 40% or less, such as 30% or less, such as 20% or less, such as 10% or less, such as 5% or less, such as 1% or less the thickness of the gypsum core.

In addition, the encasing layer, for example the one containing the perforations, may also be painted or decorated. For instance, such modifications may be conducted for aesthetic purposes to provide a more visually appealing gypsum panel. As an example, the paint utilized may be as described in US 2008/0039564, which is incorporated herein by reference in its entirety.

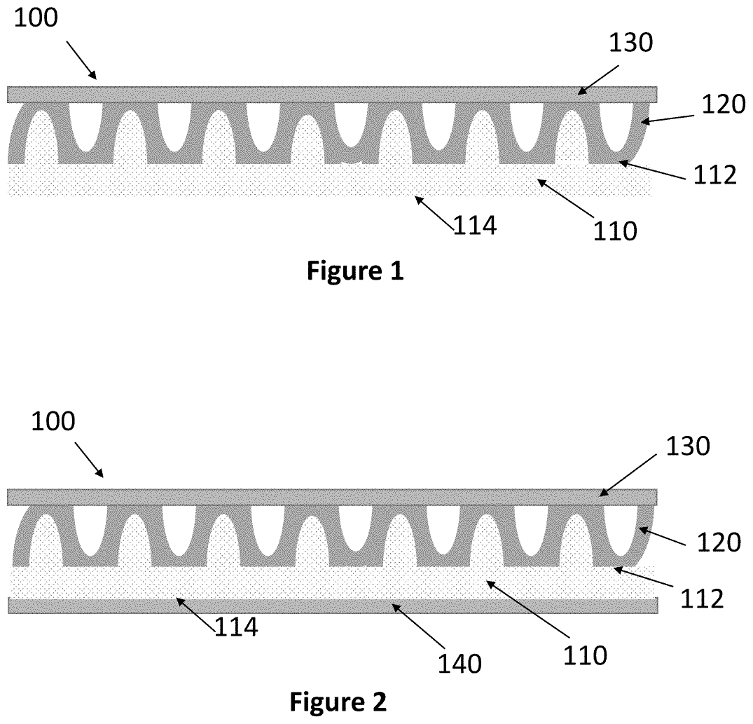

One example of a gypsum panel as disclosed herein is illustrated in FIG. 1. In FIG. 1, the gypsum panel 100 includes a gypsum core 110 having a first gypsum layer surface 112 and a second gypsum layer surface 114. A fluted layer 120 may be provided on the first gypsum layer surface 112. An encasing layer 130 may be provided on the corrugated layer 120. In FIG. 2, a second encasing layer 140 is provided on second gypsum layer surface 114.

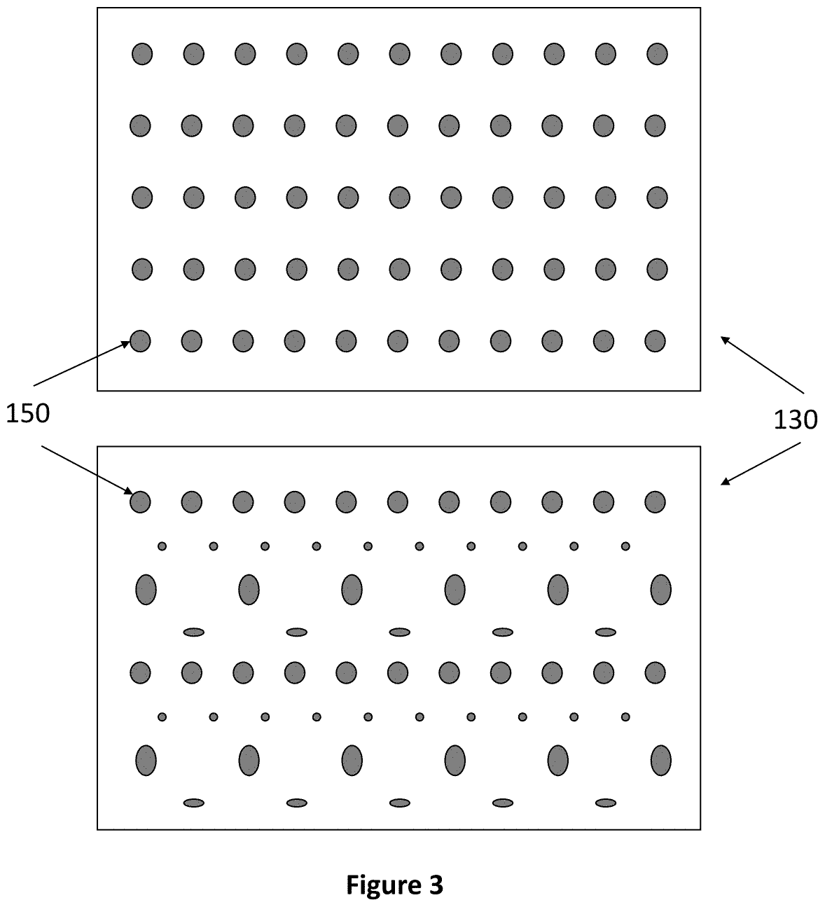

In addition, FIG. 3 illustrates encasing layer 130 including various perforations 150. However, as previously indicated, such perforation patterns and shapes are intended for illustrated purposes only. In this regard, the pattern may be uniform or non-uniform as previously indicated. In addition, the perforations may have any of a variety of shapes and/or sizes.

The present invention is also directed to a method of making a gypsum panel. The method may include a step of combining stucco and water. The method may also include combining any of the other aforementioned additives to form the gypsum slurry.

The manner in which the additives are combined is not necessarily limited. For instance, the gypsum slurry can be made using any method or device generally known in the art. In particular, the components of the slurry can be mixed or combined using any method or device generally known in the art. For instance, the components of the gypsum slurry may be combined in any type of device, such as a mixer and in particular a pin mixer.

As indicated above, the fluted layer may be provided on either or both sides of the gypsum core. In this regard, in one embodiment, the fluted layer may be provided prior to deposition of the gypsum slurry. For instance, the method may include a step of depositing the gypsum slurry onto a fluted layer. In one embodiment, the fluted layer may be conveyed on a first encasing layer on a conveyor system (i.e., a continuous system for continuous manufacture of gypsum panel). In this regard, the gypsum slurry may be directly deposited onto the fluted layer. However, as mentioned above, in one embodiment, an encasing layer may be present between the gypsum core and the fluted layer. In this regard, the method may include a step of providing an encasing layer on a fluted layer and depositing the gypsum slurry onto the encasing layer. Such encasing layer may be separately provided or it may be provided as a carrier layer for the fluted layer. Regardless, in this case, while the gypsum slurry is being deposited onto the fluted layer, it is being done so indirectly.

Furthermore, in one embodiment, the gypsum slurry may be deposited in one step for forming the gypsum core. In another embodiment, the gypsum slurry may be deposited in two steps for forming the gypsum core. For example, a first gypsum slurry may be deposited followed by a second gypsum slurry. The first gypsum slurry and the second gypsum slurry may have the same composition except that the second gypsum slurry may include a foaming agent. In this regard, the first gypsum slurry may not include a foaming agent. Accordingly, the first gypsum slurry may result in a dense gypsum layer, in particular a non-foamed gypsum layer. Such gypsum layer having a density greater than the gypsum layer formed from the second gypsum slurry, or foamed gypsum layer. By providing such a dense layer, when depositing the first gypsum slurry onto the fluted layer, it may assist in filling the flutes (i.e., the area between the peaks).

The first (or non-foamed) gypsum layer may have a thickness that is 0.5% or more, such as 1% or more, such as 2% or more, such as 3% or more, such as 4% or more, such as 5% or more, such as 10% or more, such as 15% or more the thickness of the second (or foamed) gypsum layer. The thickness may be 80% or less, such as 60% or less, such as 50% or less, such as 40% or less, such as 30% or less, such as 25% or less, such as 20% or less, such as 15% or less, such as 10% or less, such as 8% or less, such as 5% or less the thickness of the second (or foamed) gypsum layer.

The density of the second (or foamed) gypsum layer may be 0.5% or more, such as 1% or more, such as 2% or more, such as 3% or more, such as 4% or more, such as 5% or more, such as 10% or more, such as 15% or more the density of the first (or non-foamed) gypsum layer. The density of the second (or foamed) gypsum layer may be 80% or less, such as 60% or less, such as 50% or less, such as 40% or less, such as 30% or less, such as 25% or less, such as 20% or less, such as 15% or less, such as 10% or less, such as 8% or less, such as 5% or less the density of the first (or non-foamed) gypsum layer.

Next, after depositing the gypsum slurry, an encasing layer may be provided on top of the gypsum slurry such that the gypsum slurry is sandwiched between the encasing layers, in particular the fluted layer and encasing layer, in order to form the gypsum panel. However, in one embodiment wherein a fluted layer is provided on both sides of the gypsum core, a second fluted layer may be provided on the gypsum slurry. In this regard, the fluted layer may be provided directly on the gypsum slurry. Alternatively, the fluted layer may be provided on the encasing layer that is provided on the gypsum layer. In either embodiment, a further encasing layer may be provided. For instance, a further encasing layer may be provided directly on the fluted layer if desired.

In another embodiment, the fluted layer may be provided after deposition of the gypsum slurry. For instance, the method may include a step of depositing the gypsum slurry onto an encasing layer. For instance, the encasing layer may be conveyed on a conveyor system (i.e., a continuous system for continuous manufacture of gypsum panel). Next, after depositing the gypsum slurry, a fluted layer may be provided on top of the gypsum slurry. In this regard, the fluted layer may be provided directly on the gypsum slurry. However, as mentioned above, in one embodiment, an encasing layer may be present between the gypsum core and the fluted layer. In this regard, the method may also include a step of providing an encasing layer on top of the gypsum slurry prior to the step of providing the fluted layer. Thereafter, an encasing layer may be provided on the fluted layer.

Regardless of the configuration, after deposition of the gypsum slurry, the calcium sulfate hemihydrate reacts with the water to convert the calcium sulfate hemihydrate into a matrix of calcium sulfate dihydrate. Such reaction may allow for the gypsum to set and become firm thereby allowing for the continuous sheet to be cut into gypsum panels at the desired length. In this regard, the method may comprise a step of reacting calcium sulfate hemihydrate with water to form calcium sulfate dihydrate or allowing the calcium sulfate hemihydrate to convert to calcium sulfate dihydrate. In this regard, the method may allow for the slurry to set to form a gypsum panel.

The method may also comprise a step of cutting a continuous gypsum sheet into a gypsum panel. Then, after the cutting step, the method may comprise a step of supplying the gypsum panel to a heating device. For instance, such heating device may be a kiln and may allow for removal of any free water. The temperature and time required for heating in such a heating device are not necessarily limited by the present invention.

In addition, the method may also comprise a step of forming perforations in an encasing layer, in particular an encasing layer on a second fluted layer surface of the gypsum panel. Such perforations may be formed at any reasonable point during the manufacturing process and is thus not limited by the present invention. In addition, such perforations may be formed using any technique known in the art, such as those mentioned above.

The gypsum panel disclosed herein may have many applications. For instance, the gypsum panel may be used as a standalone panel in construction for the preparation of walls, ceilings, floors, etc. In one particular embodiment, the gypsum panel may be utilized as a ceiling product. When used in such application, the fluted layer may be positioned on the side of the gypsum core facing the environment of the room. In particular, the encasing layer including the perforations and the fluted layer may be positioned on the side of the gypsum core facing the environment of the room.

In addition, the gypsum panel may be installed on an existing or installed gypsum panel. As used in the present disclosure, the term “gypsum panel,” generally refers to any panel, sheet, or planar structure, either uniform or formed by connected portions or pieces, that is constructed to at least partially establish one or more physical boundaries. Such existing, installed, or otherwise established or installed wall or ceiling structures comprise materials that may include, as non-limiting examples, gypsum, stone, ceramic, cement, wood, composite, or metal materials. The installed gypsum panel forms part of a building structure, such as a wall or ceiling. The installation of the gypsum panel as disclosed herein can provide a desired acoustical performance to an existing or installed gypsum panel that does not have any sound damping or noise reducing capabilities or ineffective sound damping or noise reducing abilities.

The thickness of the gypsum panel, and, in particular, the gypsum core, is not necessarily limited and may be from about 0.25 inches to about 1 inch. For instance, the thickness may be at least ¼ inches, such as at least 5/16 inches, such as at least ⅜ inches, such as at least ½ inches, such as at least ⅝ inches, such as at least ¾ inches, such as at least 1 inch, such as at least 1.5 inches, such as at least 2 inches. In this regard, the thickness may be about any one of the aforementioned values. For instance, the thickness may be about ¼ inches. Alternatively, the thickness may be about ⅜ inches. In another embodiment, the thickness may be about ½ inches. In a further embodiment, the thickness may be about ⅝ inches. In another further embodiment, thickness may be about 1 inch. With regard to the thickness, the term “about” may be defined as within 10%, such as within 5%, such as within 4%, such as within 3%, such as within 2%, such as within 1%.

As previously mentioned, the present invention is directed to a gypsum panel that may have improved sound absorption or noise reduction properties. In addition, the gypsum panel may have other desirable properties and/or characteristics.

For instance, the weight of the gypsum panel is not necessarily limited. For instance, the gypsum panel may have a weight of 500 lbs/MSF or more, such as about 600 lbs/MSF or more, such as about 700 lbs/MSF or more, such as about 800 lbs/MSF or more, such as about 900 lbs/MSF or more, such as about 1000 lbs/MSF or more, such as about 1100 lbs/MSF or more, such as about 1200 lbs/MSF or more, such as about 1300 lbs/MSF or more, such as about 1400 lbs/MSF or more, such as about 1500 lbs/MSF or more. The weight may be about 4000 lbs/MSF or less, such as about 3000 lbs/MSF or less, such as about 2500 lbs/MSF or less, such as about 2000 lbs/MSF or less, such as about 1800 lbs/MSF or less, such as about 1600 lbs/MSF or less, such as about 1500 lbs/MSF or less, such as about 1400 lbs/MSF or less, such as about 1300 lbs/MSF or less, such as about 1200 lbs/MSF or less. Such weight may be a dry weight such as after the panel leaves the heating device (e.g., kiln).

In addition, the gypsum panel may have a density of about 5 pcf or more, such as about 10 pcf or more, such as about 15 pcf or more, such as about 20 pcf or more. The gypsum panel may have a density of about 60 pcf or less, such as about 50 pcf or less, such as about 40 pcf or less, such as about 35 pcf or less, such as about 33 pcf or less, such as about 30 pcf or less, such as about 28 pcf or less, such as about 25 pcf or less, such as about 23 pcf or less, such as about 20 pcf or less.

The gypsum panel may have a certain nail pull resistance, which generally is a measure of the force required to pull a gypsum panel off of a wall by forcing a fastening nail through the panel. The values obtained from the nail pull test generally indicate the maximum stress achieved while the fastener head penetrates through the panel surface and core. In this regard, the gypsum panel exhibits a nail pull resistance of at least about 25 lb_{f}, such as at least about 30 lb_{f}, such as at least about 35 lb_{f}, such as at least about 40 lb_{f}, such as at least about 45 lb_{f}, such as at least about 50 lb_{f}, such as at least about 55 lb_{f}, such as at least about 60 lb_{f}, such as at least about 65 lb_{f}, such as at least about 70 lb_{f}, such as at least about 75 lb_{f}, such as at least about 77 lb_{f}, such as at least about 80 lb_{f}, such as at least about 85 lb_{f}, such as at least about 90 lb_{f}, such as at least about 95 lb_{f}, such as at least about 100 lb_{f} as tested according to ASTM C1396. The nail pull resistance may be about 150 lb_{f} or less, such as about 140 lb_{f} or less, such as about 130 lb_{f} or less, such as about 120 lb_{f} or less, such as about 110 lb_{f} or less, such as about 105 lb_{f} or less, such as about 100 lb_{f} or less, such as about 95 lb_{f} or less, such as about 90 lb_{f} or less, such as about 85 lb_{f} or less, such as about 80 lb_{f} or less as tested according to ASTM C1396. Such nail pull resistance may be based upon the thickness of the gypsum panel. For instance, when conducting a test, such nail pull resistance values may vary depending on the thickness of the gypsum panel. As an example, the nail pull resistance values above may be for a ⅝ inch gypsum panel. However, it should be understood that instead of a ⅝ inch gypsum panel, such nail pull resistance values may be for any other thickness gypsum panel as mentioned herein. For instance, such nail pull resistance values may be for a ¼ inch gypsum panel, a ½ gypsum panel, a ¾ inch gypsum panel, a 1 inch gypsum panel, etc.

The gypsum panel may have a certain compressive strength. For instance, the compressive strength may be about 150 psi or more, such as about 200 psi or more, such as about 250 psi or more, such as about 300 psi or more, such as about 350 psi or more, such as about 375 psi or more, such as about 400 psi or more, such as about 500 psi or more as tested according to ASTM C473. The compressive strength may be about 3000 psi or less, such as about 2500 psi or less, such as about 2000 psi or less, such as about 1700 psi or less, such as about 1500 psi or less, such as about 1300 psi or less, such as about 1100 psi or less, such as about 1000 psi or less, such as about 900 psi or less, such as about 800 psi or less, such as about 700 psi or less, such as about 600 psi or less, such as about 500 psi or less. Such compressive strength may be based upon the thickness of the gypsum panel. For instance, when conducting a test, such compressive strength values may vary depending on the thickness of the gypsum panel. As an example, the compressive strength values above may be for a ⅝ inch gypsum panel. However, it should be understood that instead of a ⅝ inch gypsum panel, such compressive strength values may be for any other thickness gypsum panel as mentioned herein. For instance, such compressive strength values may be for a ¼ inch gypsum panel, a ½ gypsum panel, a ¾ inch gypsum panel, a 1 inch gypsum panel, etc.

In addition, the gypsum panel may have a core hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f} as tested according to ASTM C1396. The gypsum panel may have a core hardness of 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C1396. In addition, the gypsum panel may have an end hardness according to the aforementioned values. Further, the gypsum panel may have an edge hardness according to the aforementioned values. Such hardness values may be based upon the thickness of the gypsum panel. For instance, when conducting a test, such hardness values may vary depending on the thickness of the gypsum panel. As an example, the hardness values above may be for a ⅝ inch gypsum panel. However, it should be understood that instead of a ⅝ inch gypsum panel, such hardness values may be for any other thickness gypsum panel as mentioned herein. For instance, such hardness values may be for a ¼ inch gypsum panel, a ½ gypsum panel, a ¾ inch gypsum panel, a 1 inch gypsum panel, etc.

### Example

Various samples were created to evaluate the performance of the gypsum panel by varying weight/density, caliper, perforation size, and perforation spacing. Each sample had a corrugated/fluted layer that replaced a non-corrugated/fluted layer (e.g., standard paper facer). In particular, the corrugated/fluted layer was a single-faced layer wherein the gypsum slurry was provided on the side containing the flutes. In addition, the flutes were A flutes wherein there were 32-34 flutes/foot.

For evaluating NRC values, an impedance tube was utilized to generate data across the full Hertz spectrum and specifically at Hertz frequencies that make up the NRC value (i.e., 0.250 Hz, 500 Hz, 1000 Hz, and 2000 Hz). In particular, the data was generated based on ASTM E1050 using multiple impedance tube sizes/diameters.

The thickness of the gypsum panel was varied to evaluate the effect on the NRC values. The results are provided in the table below.

| Sample | Thickness | NRC Value |
|---|---|---|
| Comparative Sample 1 | 0.5 | 0.04 |
| (w/o fluted layer) | | |
| Sample 1 | 0.75 | 0.19 |
| Sample 2 | 0.75 | 0.41 |
| Sample 3 | 0.75 | 0.32 |
| Sample 4 | 1 | 0.25 |
| Sample 5 | 1 | 0.34 |
| Sample 6 | 1.5 | 0.17 |
| Sample 7 | 1.5 | 0.23 |

The weight of the gypsum panel was varied to evaluate the effect on the NRC values. The results are provided in the table below.

| | | |
|---|---|---|
| | Board Weight | |
| Sample | (lbs/MSF) | NRC Value |

| | | | |
|---|---|---|---|
| Comparative Sample 2 | 1425 | 0.04 | 0.04 |
| (w/o fluted layer) | | | |
| Sample 8 | 671 | 0.32 | — |
| Sample 9 | 698 | 0.29 | 0.31 |
| Sample 10 | 744 | 0.42 | — |
| Sample 11 | 794 | 0.24 | — |
| Sample 12 | 794 | 0.27 | 0.31 |
| Sample 13 | 812 | 0.22 | — |
| Sample 14 | 867 | 0.19 | — |
| Sample 15 | 871 | 0.32 | — |
| Sample 16 | 876 | 0.32 | — |
| Sample 17 | 876 | 0.34 | 0.28 |
| Sample 18 | 902 | 0.29 | — |
| Sample 19 | 902 | 0.27 | — |
| Sample 20 | 923 | 0.46 | — |
| Sample 21 | 957 | 0.19 | — |
| Sample 22 | 959 | 0.23 | — |
| Sample 23 | 978 | 0.17 | 0.27 |
| Sample 24 | 1028 | 0.25 | — |
| Sample 25 | 1067 | 0.41 | — |
| Sample 26 | 1067 | 0.29 | — |
| Sample 27 | 1067 | 0.17 | — |
| Sample 28 | 1067 | 0.25 | — |
| Sample 29 | 1071 | 0.14 | — |
| Sample 30 | 1074 | 0.28 | 0.26 |
| Sample 31 | 1168 | 0.25 | 0.25 |

The diameter of the perforations on the fluted layer was varied to evaluate the effect on the NRC values. The results are provided in the table below.

| | |
|---|---|
| Perforation | NRC Value |

| Sample | Diameter (inches) | Value | Avg. |
|---|---|---|---|
| Sample 32 | 0.052 | 0.32 | 0.27 |
| Sample 33 | | 0.24 | |
| Sample 34 | | 0.22 | |
| Sample 35 | | 0.32 | |
| Sample 36 | | 0.34 | |
| Sample 37 | | 0.27 | |
| Sample 38 | | 0.19 | |
| Sample 39 | | 0.23 | |
| Sample 40 | | 0.17 | |
| Sample 41 | | 0.41 | |
| Sample 42 | | 0.25 | |
| Sample 43 | 0.1495 | 0.29 | 0.30 |
| Sample 44 | | 0.42 | |
| Sample 45 | | 0.27 | |
| Sample 46 | | 0.25 | |
| Sample 47 | | 0.29 | |
| Sample 48 | | 0.28 | |

The spacing of the perforations on the fluted layer was varied to evaluate the effect on the NRC values. The results are provided in the table below.

| | Perforation | |
|---|---|---|
| Sample | Spacing (inches) | NRC Value |
| Sample 49 | 0.375 | 0.28 |
| Sample 50 | 0.375 | 0.29 |
| Sample 51 | 0.625 | 0.20 |
| Sample 52 | 0.75 | 0.24 |
| Sample 53 | 1.125 | 0.20 |
| Sample 54 | 1.125 | 0.23 |

As indicated above, providing a fluted layer can improve the NRC performance of a gypsum panel. In addition, certain parameters of the gypsum panel and/or fluted layer can affect the NRC values.

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1-27. (canceled)

28. A gypsum panel, comprising:
a gypsum core having a first gypsum layer surface and a second gypsum layer surface opposite the first gypsum layer surface, and
a fluted layer having a first fluted layer surface and a second fluted layer surface opposite the first fluted layer surface, the first fluted layer surface facing the first gypsum layer surface.

29. The gypsum panel of claim 28, wherein the fluted layer is disposed directly on the first gypsum layer surface.

30. The gypsum panel of claim 28, wherein an encasing layer is disposed between the first gypsum layer surface and the first fluted layer surface.

31. The gypsum panel of claim 28, wherein an encasing layer is adjacent the second fluted layer surface.

32. The gypsum panel of claim 31, wherein the encasing layer includes a plurality of perforations.

33. The gypsum panel of claim 32, wherein the perforations have an irregular size distribution.

34. The gypsum panel of claim 32, wherein the perforations have a regular size distribution.

35. The gypsum panel of claim 32, wherein the perforations cover from 0.5% to 70% of the area of the encasing layer.

36. The gypsum panel of claim 31, wherein the encasing layer comprises a glass fiber mat encasing layer.

37. The gypsum panel of claim 28, wherein the fluted layer includes a coating.

38. The gypsum panel of claim 37, wherein the coating includes a flame retardant, an intumescent material, a charring agent, a polymer, a nonwoven, a foam, or a combination thereof.

39. The gypsum panel of claim 28, wherein the fluted layer includes from 5 to 300 flutes per foot.

40. The gypsum panel of claim 28, wherein the fluted layer has a thickness of from 0.01 mm to 10 mm.

41. The gypsum panel of claim 28, wherein the fluted layer has a basis weight of from 0.001 pounds/ft² to 2 pounds/ft².

42. The gypsum panel of claim 28, wherein 40% or more of the space between the fluted layer and the gypsum core is occupied by the gypsum core.

43. The gypsum panel of claim 28, wherein the fluted layer is a double wall layer including a first fluted layer, a second fluted layer, and an encasing layer separating the first fluted layer and the second fluted layer.

44. The gypsum panel of claim 28, wherein the fluted layer is made from a cellulosic material.

45. The gypsum panel of claim 28, wherein the fluted layer is made from a metal.

46. The gypsum panel of claim 28, wherein the panel has an NRC value of from 0.2 to 0.8 as determined in accordance with ASTM C423.

47. A method of forming the gypsum panel of claim 28, the method comprising:
depositing a gypsum slurry comprising stucco and water onto a fluted layer,
providing an encasing layer on the gypsum slurry, and
allowing the stucco to convert to calcium sulfate dihydrate.

48. A method of forming the gypsum panel of claim 28, the method comprising:
depositing a gypsum slurry comprising stucco and water onto a first encasing layer;
providing a fluted layer on the gypsum slurry,
providing a second encasing layer on the fluted layer, and
allowing the stucco to convert to calcium sulfate dihydrate.
